(19) United States
(12) Patent Application Publication
(10) Pub. No.: US 2018/0124305 A1
(43) Pub. Date: May 3, 2018

(54) IMAGING APPARATUS, CONTROL METHOD THEREFOR, AND STORAGE MEDIUM

(71) Applicant: CANON KABUSHIKI KAISHA, Tokyo (JP)

(72) Inventor: Takashi Kobayashi, Tokyo (JP)

(21) Appl. No.: 15/791,826

(22) Filed: Oct. 24, 2017

(30) Foreign Application Priority Data
Oct. 31, 2016 (JP) 2016-213541

(51) Int. Cl. H04N 5/232

(52) U.S. Cl. CPC H04N 5/23216; H04N 5/23293

(57) ABSTRACT

An imaging apparatus includes an acquisition unit configured to acquire a luminance range that allows gradation expression in an image to be captured, based on setting information when an image is generated, and a presentation unit configured to present a luminance range that allows gradation expression in an image to be captured.

### BACKGROUND OF THE INVENTION

### Field of the Invention

The aspect of the embodiments relates to control of an imaging apparatus.

### Description of the Related Art

In recent years, image output performance of display apparatuses has improved, and the dynamic range of an image that allows gradation expression in a display apparatus has expanded. Therefore, an object can be displayed with the same brightness as that of the object when viewed, achieving an enhanced sense of presence. As the output performance of the display apparatuses is thus improved, a conversion characteristic of a display apparatus for displaying a wide dynamic range image is standardized as “-Society of Motion Picture and Television Engineers (SMPTE) ST 2084:2014”.

In addition, “Report ITU-R BT.2246-1 (08/2012)” scientifically verifies that, as for human visual characteristics, a just noticeable difference (JND) that can be recognized varies depending on luminance. The above-mentioned “SMPTE ST 2084:2014” is a standard established by associating a code value of an image signal and a luminance value to be displayed by a display apparatus, based on this verification. Therefore, for an image signal to be input into a display apparatus, it is expected to perform photoelectric conversion based on an inverse function of this conversion characteristic.

In the above-described standard, a code value of an image and an absolute luminance value are associated and displayed when the image is output to a display apparatus. Therefore, a user is to carry out image capturing, while being aware of an output luminance range of a display apparatus, and a luminance range that allows gradation expression during the image capturing.

Japanese Patent Application Laid-Open No. 2005-191985 discusses a method for displaying luminance information of an object as a histogram, using absolute luminance. A user can make camera settings such as exposure, while confirming the absolute luminance information of the object. However, it is difficult for an ordinary user to associate the absolute luminance and the exposure setting of the camera immediately because this requires knowledge and experience. There arises an issue in that it is difficult for the user to understand intuitively how the camera setting is to be changed to alter luminance that allows gradation expression.

### SUMMARY OF THE INVENTION

According to an aspect of the embodiments, an imaging apparatus includes an acquisition unit configured to acquire a luminance range that allows gradation expression in an image to be captured, based on setting information when an image is generated, and a presentation unit configured to present a luminance range that allows gradation expression in an image to be captured.

Further features of the disclosure will become apparent from the following description of exemplary embodiments with reference to the attached drawings.

### BRIEF DESCRIPTION OF THE DRAWINGS

FIG. 1 is a block diagram illustrating a configuration of a digital video camera according to an exemplary embodiment.

FIG. 2 is a block diagram illustrating an internal configuration of a system control unit of a first exemplary embodiment.

FIG. 3 is a flowchart illustrating processing according to the first exemplary embodiment.

FIG. 4 is a diagram illustrating a photoelectric conversion characteristic according to the first exemplary embodiment as an example.

FIGS. 5A and 5B are diagrams each illustrating a display example according to the first exemplary embodiment.

FIG. 6 is a block diagram illustrating an internal configuration of a system control unit according to a second exemplary embodiment.

FIG. 7 is a flowchart illustrating processing according to the second exemplary embodiment.

FIGS. 8A and 8B are diagrams each illustrating an operation example according to the second exemplary embodiment.

### DESCRIPTION OF THE EMBODIMENTS

Exemplary embodiments of the disclosure will be described in detail below. Each of the exemplary embodiments to be described below is only an example for implementing the disclosure, and may be modified or altered as appropriate according to various configurations and various conditions of an apparatus to which the disclosure is applied. The disclosure is not limited to the following exemplary embodiments. Moreover, a part of each of the exemplary embodiments to be described below may be combined with another, as appropriate.

### <Apparatus Configuration>

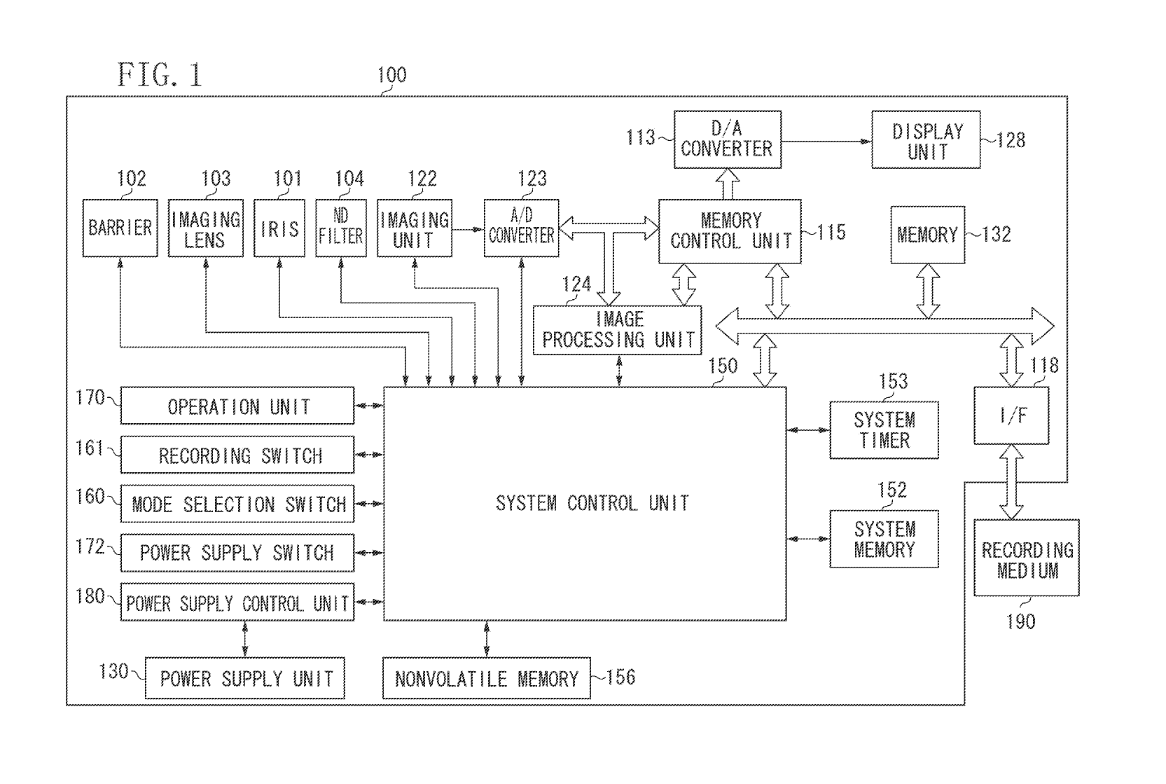

First, a configuration and functions of a digital video camera 100 according to a first exemplary embodiment of the disclosure will be described with reference to FIG. 1.

In FIG. 1, an imaging lens 103 is a lens group including a zoom lens and a focus lens, and forms an object image. An iris 101 is used to adjust the quantity of incident light. A natural density (ND) filter 104 is used to adjust the quantity of incident light (to dim incident light) separately from the iris 101. An imaging unit 122 is an imaging sensor configured of a charge coupled device (CCD) sensor or a complementary metal oxide semiconductor (CMOS) sensor that converts an optical image of an object into an electrical signal. The imaging unit 122 also has functions such as control of accumulation by an electronic shutter, and changing of an analog gain and a readout speed. An analog-to-digital (A/D) converter 123 is used to convert an analog signal output from the imaging unit 122 into a digital signal. A barrier 102 covers an imaging system of the digital video camera (hereinafter referred to as the camera) 100, thereby preventing dirt and damage to the imaging system that includes the imaging lens 103, the iris 101, and the imaging unit 122.

An image processing unit 124 performs processing such as color conversion processing, gamma correction, and digital gain addition, on data from the A/D converter 123 or data from a memory control unit 115. Further, the image processing unit 124 performs predetermined computation processing by using captured image data. Based on a computation result obtained thereby, a system control unit 150 performs control such as exposure control, ranging control, and white balance control. Processing such as autofocus (AF) processing of a through the lens (TTL) system, automatic exposure (AE) processing, and automatic white balance (AWB) processing are thereby performed. The image processing unit 124 will be described in detail below.

Output data from the A/D converter 123 is written in a memory 132 via the image processing unit 124 and the memory control unit 115, or directly without the memory control unit 115. The memory 132 stores image data converted into digital data by the A/D converter 123 after being obtained by the imaging unit 122, and image data to be displayed by a display unit 128. The memory 132 has a storage capacity sufficient for storage of a moving image and sound of a predetermined length of time.

The memory 132 also serves as a memory (a video memory) for image display. A digital-to-analog (D/A) converter 113 converts data for image display stored in the memory 132 into an analog signal, and supplies the analog signal to the display unit 128. In this way, the image data for display written in the memory 132 is displayed by the display unit 128, via the D/A converter 113. The display unit 128 performs display corresponding to the analog signal from the D/A converter 113, on a display device such as a liquid crystal display (LCD). The digital signal resulting from the AD conversion by the A/D converter 123 is accumulated in the memory 132, and the accumulated digital data is subjected to analog conversion by the D/A converter 113. The converted signal is then consecutively transferred to and then displayed by the display unit 128. The display unit 128 thus functions as an electronic viewfinder (EVF) and can display a live view image.

A nonvolatile memory 156 is an electrically erasable and recordable memory. For example, an electrically erasable programmable read only memory (EEPROM) is used for the nonvolatile memory 156. The nonvolatile memory 156 stores constants and a program for operation of the system control unit 150. The program mentioned here is a program for executing various flowcharts to be described below in the present exemplary embodiment.

The system control unit 150 controls the entire camera 100. The system control unit 150 implements each processing to be described below of the present exemplary embodiment, by executing the program recorded in the nonvolatile memory 156 described above. For a system memory 152, a random access memory (RAM) is used. Constants, variables, and the program read from the nonvolatile memory 156 for the operation of the system control unit 150 are loaded into the system memory 152. In addition, the system control unit 150 further performs display control by controlling components such as the memory 132, the D/A converter 113, and the display unit 128.

A system timer 153 is a clocking unit that measures the time to be used for various kinds of control and the time of a built-in clock.

A mode selection switch 160, a recording switch 161, and an operation unit 170 are operation means for inputting various operation instructions into the system control unit 150.

The mode selection switch 160 selects any of modes including a moving-image recording mode, a still-image recording mode, and a playback mode, as an operating mode of the system control unit 150. Modes included in the moving-image recording mode and the still-image recording mode include an automatic image capturing mode, an automatic scene determination mode, a manual mode, various scene modes each providing image-capturing setting for each image-capturing scene, a program AE mode, and a custom mode. Any of these modes included in the moving-image recording mode can be directly selected with the mode selection switch 160. Alternatively, after the moving-image recording mode is selected with the mode selection switch 160, any of these modes included in the moving-image recording mode may be selected using other operation member. The recording switch 161 switches between an imaging standby state and an imaging state. The system control unit 150 starts a series of operations from signal readout from the imaging unit 122 to writing of recording data into a recording medium 190, in response to operation of the recording switch 161.

Operation members of the operation unit 170 are each appropriately assigned a function for each scene, by selecting and operating various kinds of function icons displayed in the display unit 128. Therefore, these operation members act as various function buttons. Examples of the function buttons include an end button, a return button, an image forward button, a jump button, a narrowing-down button, and an attribute change button. For example, when the menu button is pressed, various settable menu screens are displayed in the display unit 128. A user can intuitively perform various kinds of setting by using the menu screen displayed in the display unit 128, a four-direction (up, down, right, and left) button, and a SET button.

A power supply control unit 180 includes a battery detecting circuit, a direct current to direct current (DC-DC) converter, and a switch circuit for switching a block to be energized. The power supply control unit 180 detects presence/absence of a battery attached, the type of a battery, and a remaining battery level. Further, the power supply control unit 180 controls the DC-DC converter, based on a result of the detection and an instruction from the system control unit 150, and thereby supplies a necessary voltage for a necessary period, to each of the components including the recording medium 190.

A power supply unit 130 includes a primary battery such as an alkaline battery or lithium battery, a secondary battery such as a NiCd battery, NiMH battery, or lithium-ion battery, and an alternating current (AC) adapter. An interface (I/F) 118 is an interface with the recording medium 190 such as a memory card or a hard disk, or an interface with an external device. FIG. 1 illustrates a state where connection with the recording medium 190 is established. Examples of the recording medium 190 include a recording medium such as a memory card for recording a captured image. The recording medium 190 is configured of a medium such as a semiconductor memory or a magnetic disk.

### <Internal Configuration of System Control Unit>

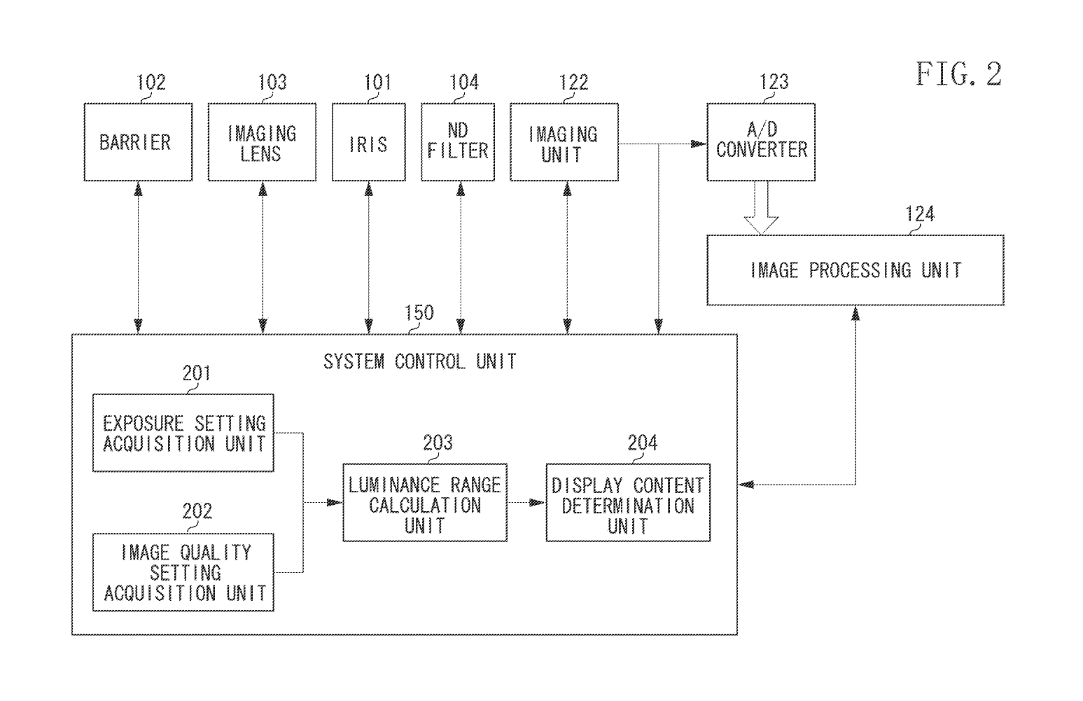

Next, an internal configuration of the system control unit 150 of the present exemplary embodiment will be described with reference to FIG. 2.

FIG. 2 illustrates a peripheral portion and an internal configuration of the system control unit 150. An exposure setting acquisition unit 201 acquires exposure information including at least one of an aperture value, a shutter speed, an International Standardization Organization (ISO) sensitivity, and ND information (such as information about a density of the ND filter 104). The exposure setting acquisition unit 201 transmits the acquired exposure information to a luminance range calculation unit 203. As for the ISO sensitivity, the exposure setting acquisition unit 201 acquires sensitivity setting of the imaging unit 122, a sensitivity magnification in the A/D converter 123, and a sensitivity amplification factor in the image processing unit 124, separately. An image quality setting acquisition unit 202 acquires image quality setting information about image processing to be performed in the image processing unit 124. The image quality setting information includes at least one of gradation conversion characteristic, noise reduction setting, and noise addition setting. The image quality setting acquisition unit 202 transmits the acquired image quality setting information to the luminance range calculation unit 203. Based on each piece of information from the exposure setting acquisition unit 201 and the image quality setting acquisition unit 202, the luminance range calculation unit 203 calculates a luminance range of an object that allows gradation expression by a captured image. A method for calculating the luminance range will be described below. According to the luminance range calculated by the luminance range calculation unit 203, a display content determination unit 204 determines a display content to be displayed to the user. The determined display content may be displayed in an entire display section as text information. Alternatively, display data may be generated for a part of the display section, and then transmitted to the image processing unit 124 to generate an image to be superimposed and displayed on a captured image. The display method is not limited in particular.

### <Display Data Generation Processing>

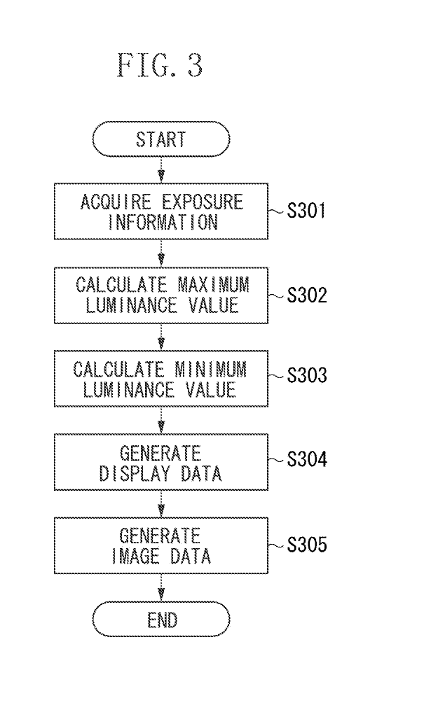

Next, display data generation processing of the present exemplary embodiment will be described with reference to FIG. 3.

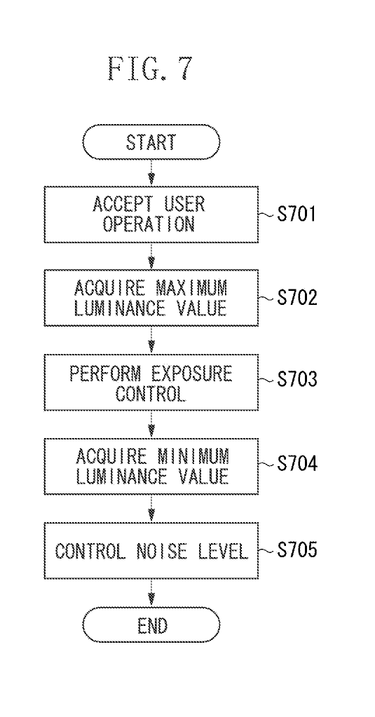

The system control unit 150 implements the processing in FIG. 3, by reading the program recorded in the nonvolatile memory 156 into the system memory 152 and executing the read program. This also holds true for FIG. 7 to be described below.

In step S301, the system control unit 150 acquires exposure information by using the exposure setting acquisition unit 201, and acquires image quality setting information by using the image quality setting acquisition unit 202.

In step S302, the system control unit 150 calculates a maximum luminance value by the luminance range calculation unit 203, using the information acquired in step S301. Specifically, an absolute luminance value that can express a code value in an image signal is calculated as the maximum luminance value. In this example, “cd/m²” is used as the unit of the absolute luminance value, but a different unit of a numerical value such as “nit” or “lux” may be used.

A method for associating a code value of an image signal before gradation conversion and an absolute luminance value of an object field will be described using specific numerical values. The description will be provided assuming that the image before the gradation conversion is a RAW image and a characteristic of linearly performing photoelectric conversion of an object luminance is to be performed. However, the present exemplary embodiment is also applicable to a case other than the linear conversion, by calculating a luminance value considering a conversion characteristic. A method for determining a reference By value, which is a By value of a reference signal in Additive System of Photographic Exposure (APEX) expression, is as follows.

Reference Bv value=2^{(Av+Tv-Sv)}×(0.32×k) [cd/m^{2]} (1)

Here, in the expression (1), Av is an aperture value, Tv is a shutter speed, and Sv is an exposure (an exposure control value) determined by converting an image-capturing sensitivity into the APEX unit. Further, k is a calibration factor, and used when converting a luminance value expressed in the APEX unit into cd/m² (or nit) that is the unit of the absolute luminance, in order that the input becomes 18% gray. In the present exemplary embodiment, k=12.5 is assumed. To convert a luminance value Z expressed in the APEX unit into an absolute luminance value X, a calculation can be performed using X=2^{Z}×(0.32×k), based on a relational expression of log₂ (X/0.32×k)=Z. For example, in a case of Av=F4.0, Tv= 1/128, and Sv=ISO sensitivity 200, the reference Bv value is calculated from the expression (1), as follows.

Reference Bv value=2^{(4(Av)+7(Tv)-6(Sv))}×(0.32×12.5)=128 [cd/m²]

At this time, assume that the dynamic range of the camera 100 is 1200%, the ratio of a reference luminance value to an upper limit of the luminance value is 20%, and the bit number of data is 14. In this case, the code of a reference signal is determined by substituting these numerical values into the following expression (2) for determining the code of a reference signal.

Code of reference signal=(2^{bit} number)×(reference luminance value[%]/dynamic range[%]) (2)

As a result, the code of the reference signal is determined to be 273 as follows.

Code of reference signal=(214)×(20/1200)=273

Since the code value of the reference signal is 273, and the reference By value is 128 cd/m², the By value of a maximum code value 16383 is determined to be 7681 cd/m², assuming that the code value of the image signal is subjected to linear photoelectric conversion with respect to a light amount. Light amounts equal to or larger than 7681 cd/m² are expressed as the maximum code value 16383,and thus cannot be distinguished. Therefore, the maximum value of a code value at which gradation is distinguishable is 16382 as an image signal, and a luminance value corresponding thereto is 7680 cd/m². Although the calculation based on precise definition is performed here, no problem arises even if 7681 cd/m² is used as a luminance value corresponding to the maximum code value 16383. The maximum luminance value is thus calculated in step S302.

In step S303, the system control unit 150 calculates a minimum luminance value based on a noise level, by using the luminance range calculation unit 203.

As described above, 7681 cd/m² is expressed by the number of codes of 16384. Therefore, one code value is 0.47 cd/m². For this reason, 0.47 cd/m² is the minimum luminance value, which allows gradation expression differently from a complete light-shielding when the quantity of incident light is zero. Meanwhile, a captured image includes a noise component. Therefore, even if gradation expression is possible as a code value, distinguishing of gradation may not be possible because the code value being buried in the noise. In other words, a code value, which allows visual recognition as being distinguished from a noise level, is desirable for expression as the luminance of an object. Various guidelines have been proposed for a relationship between a noise level and a signal that allows visual recognition. However, here, it is not necessary to be bound by a specific guideline.

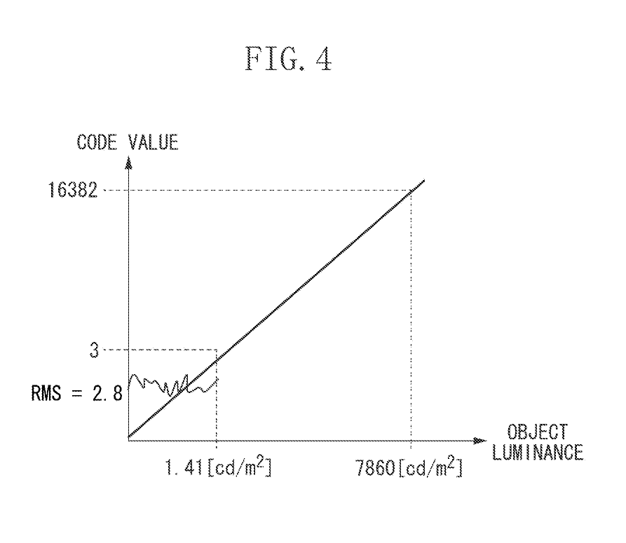

In the present exemplary embodiment, as a method for expressing a noise level, which is one of the guidelines, a method in which, using an RMS value that expresses an average level within 10 of a distribution, a smallest code value exceeding the RMS value is calculated as a minimum luminance that can be visually recognized. There exist various methods for calculating a noise level including the RMS value. It is also possible to make a modification according to sensitivity setting and noise reduction setting in a camera. In the present exemplary embodiment, for example, the RMS value is calculated from a table prepared beforehand based on the exposure setting, the noise reduction setting, and the noise addition setting and the gradation conversion characteristic of a camera. However, this is only an example of the calculation method, and the calculation method is not limited to this example. FIG. 4 illustrates an example of a photoelectric conversion characteristic with a noise with RMS=2.8. In this case, the smallest code value exceeding 2.8 is a code value 3, which is the smallest code value that allows visual recognition. Corresponding to the code value 3, 1.41 cd/m² is calculated as the minimum luminance.

In step S301 to step S303 described above, the luminance range of the object that allows gradation expression in the captured image, depending on the exposure setting and the image quality setting of the camera 100. This processing does not consider the gradation conversion characteristic, and in reality, there may be a case where gradation expression is not possible in the code value due to the gradation conversion. For example, as for an input signal of a part in which the slope of a conversion characteristic is less than 1 in a gradation conversion characteristic for converting an image signal of 14 bits into 10 bits, distinguishing of gradation is not possible in a code value after the gradation conversion, although the input signal can express gradation. In such a case, as the code value after conversion, the input luminance of a code value in which gradation can be distinguished is to be calculated as a minimum luminance value/a maximum luminance value.

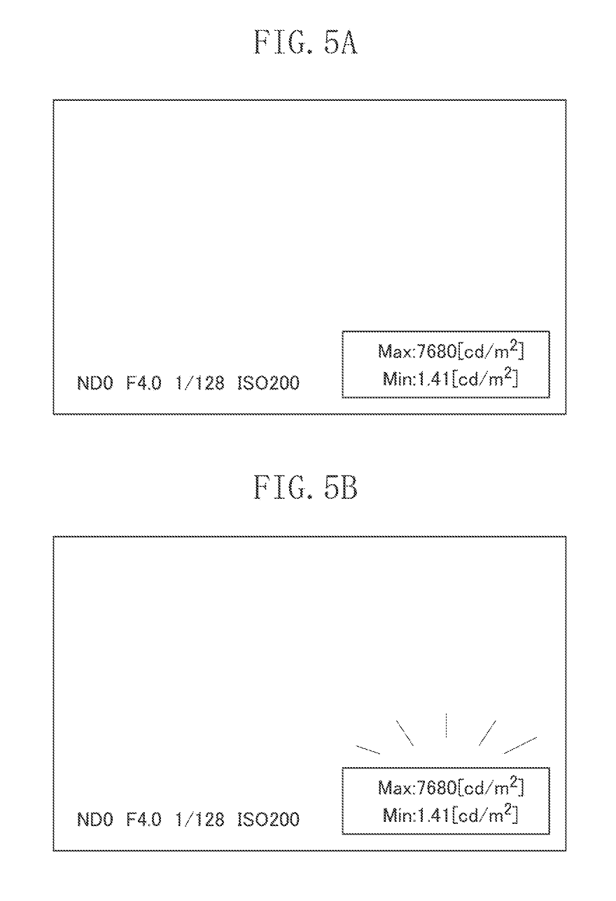

In step S304, the system control unit 150 generates display data based on a display content determined by the display content determination unit 204. FIG. 5A illustrates a conceivable form of the display content. This form displays a luminance range including a maximum luminance and a minimum luminance on a captured image in a superimposed manner. In a case that a luminance range is compared with a standard of a luminance range in which gradation can be expressed in a display apparatus, and does not meet the standard, the form may be such that the displayed luminance range blinks to give a warning to the user, as illustrated in FIG. 5B. Similarly, according to the result of a comparison with the standard of the display apparatus, a warning may be given by changing the color of texts, displaying a warning icon without displaying the luminance range, or causing an icon conforming to the standard to blink. As long as the display content is determined according to the luminance range, the display content is not limited to a particular form.

In step S305, the system control unit 150 generates image data for display, from the display data generated in step S304. For example, the system control unit 150 generates image data in which the display data is superimposed on the captured image. The system control unit 150 then outputs the generated image data to a display apparatus. In a case where the display data is displayed without being superimposed on the captured image, the processing in step S305 is unnecessary.

According to the present exemplary embodiment, the gradation of 0 to 7680 cd/m² can be expressed by the photoelectric conversion characteristic of the image before the gradation conversion. In the present exemplary embodiment, the image before the gradation conversion is assumed to have the characteristic of linearly expressing the object luminance. However, for a characteristic of non-linear photoelectric conversion with respect to a light amount, a luminance range can also be obtained by calculating a luminance value corresponding to each of a maximum code value and a minimum code value, and performing a similar computation.

The image data generated by the processing described above is output to a display apparatus and then displayed by the display apparatus, so that the user can be presented with a luminance range that allows gradation expression. Accordingly, the user can intuitively operate the camera in connection with the luminance range.

Next, a second exemplary embodiment will be described.

A configuration of a camera according to the present exemplary embodiment is similar to that illustrated in FIG. 1 of the first exemplary embodiment.

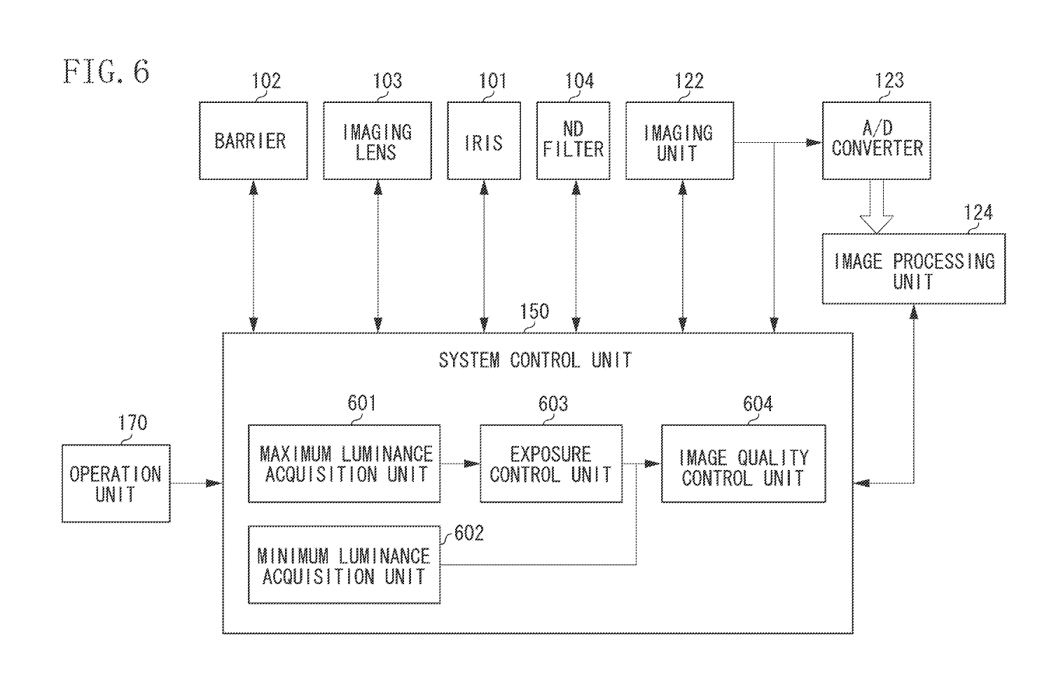

An internal configuration of a system control unit according to the present exemplary embodiment will be described with reference to FIG. 6.

In FIG. 6, a system control unit 150 receives an operation signal input via an operation unit 170 from a user, and notifies a maximum luminance acquisition unit 601 and a minimum luminance acquisition unit 602 of the signal, so that conversion into a maximum luminance and a minimum luminance is performed. An exposure control unit 603 performs exposure control, based on the maximum luminance acquired by the maximum luminance acquisition unit 601. An image quality control unit 604 performs image-quality control such as noise reduction control, noise addition control, and gradation control, by using the result of the exposure control performed by the exposure control unit 603 and the minimum luminance acquired by the minimum luminance acquisition unit 602.

Next, display data generation processing of the present exemplary embodiment will be described with reference to FIG. 7.

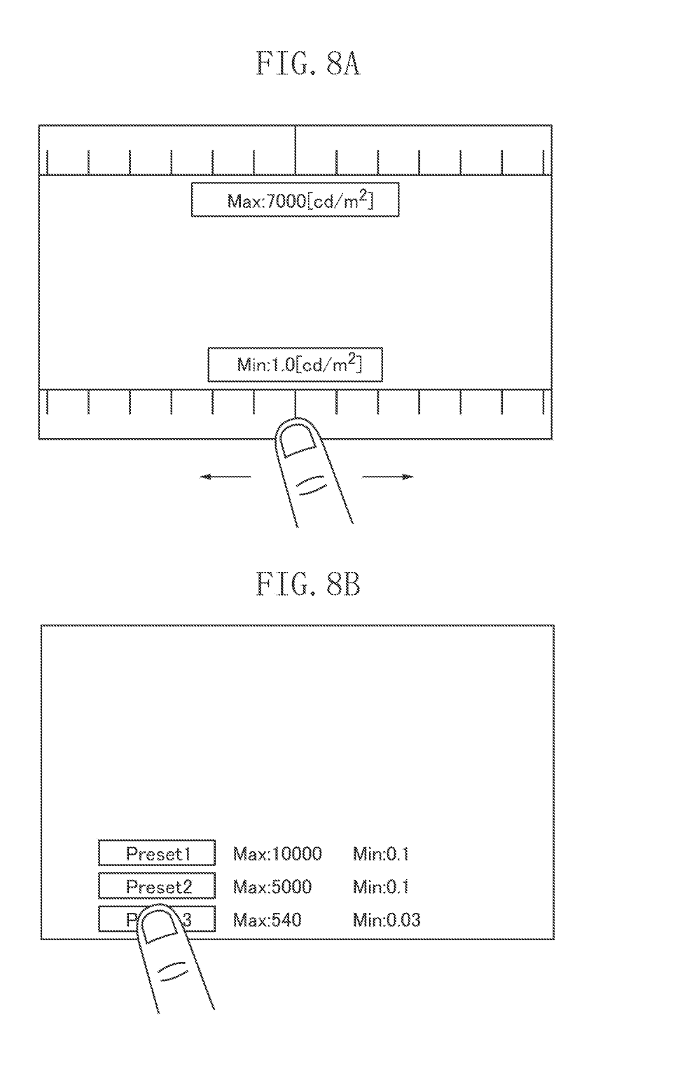

In step S701, the system control unit 150 accepts user operation via the operation unit 170. FIGS. 8A and 3B each illustrate how a user operates a setting screen of the camera. In a setting screen illustrated in FIG. 8A, a maximum luminance and a minimum luminance can be separately input by operation of a corresponding slider. As for a luminance range of a display apparatus that displays a captured image, there are some standards each established by an industrial group or an international standardization organization. It can be considered that a user may wish to set a maximum luminance and a minimum luminance individually for a luminance range meeting a device standard, in consideration of a standard of a display apparatus that displays a captured image. To satisfy such a demand, the maximum luminance and the minimum luminance can be individually set, in the setting screen illustrated in FIG. 8A. On the other hand, FIG. 8B illustrates an example of a setting screen in which the maximum luminance and the minimum luminance can be set as a combination, and one or more combinations of them are preset. The user can select a desired preset combination in this setting screen. In this example, frequently-used luminance ranges of a display apparatus are prepared by being preset, in consideration of the standard of the display apparatus, so that the user selects a desired luminance range according to an intended use. Further, the preset maximum luminance and minimum luminance may be editable beforehand by the user, so that the user may select initial values for exposure setting or image quality setting. Subsequently, the user may make a fine adjustment by performing input operation in a manner illustrated in FIG. 8A.

In the present exemplary embodiment, FIGS. 8A and 8B each illustrate an example of input operation, but the input operation is not limited to these examples. The maximum luminance and the minimum luminance may be simultaneously settable as a combination.

In step S702, the system control unit 150 acquires a maximum luminance value from the maximum luminance and the minimum luminance input in step S701. In the example illustrated in FIG. 8A, the maximum luminance value is 7000 cd/m².

In step S703, the system control unit 150 performs exposure control, based on the maximum luminance acquired in step S702. As to the exposure control based on the maximum luminance, the control for calculating the maximum luminance from the exposure setting is described in the first exemplary embodiment. The processing here, however, is performed in an opposite manner. Specifically, if an input maximum luminance value is 7000 cd/m², the maximum code value 16382 is 7000 cd/m². In this case, a reference By value is calculated as follows.

Reference Bv value=128×(7000/7680)=117 cd/m²

If the reference By value thus calculated is allocated to exposure elements, an aperture value is F4.0, a shutter speed is 1/117, a sensitivity is ISO 200, and an ND filter is not used. For allocating the reference By value to the exposure elements, there are various methods, and a method to be employed is not limited to the above-described combination. As for the combination as well, a combination of specific exposure element priorities (such as Av priority, Tv priority, and Sv priority) may be used, or a specific combination method expected to produce an image quality effect may be used. The exposure elements are controlled to the calculated control values.

In step S704, the system control unit 150 acquires a minimum luminance value from the maximum luminance and the minimum luminance input in step S701. In the example illustrated in FIG. 8A, the minimum luminance value is 1.0 cd/m².

In step S705, the system control unit 150 controls a noise level, by using the result of the exposure control performed by the exposure control unit 603, and the minimum luminance acquired by the minimum luminance acquisition unit 602. Due to the above-described exposure control, the maximum code value 16382 that allows gradation expression corresponds to 7000 cd/m². Accordingly, a luminance value per code value is as follows.

1 code value=7000/16382=0.428 cd/m²

Therefore, a luminance expressed by a minimum code value 1 is 0.428 cd/m². Meanwhile, there is a case where, since an image signal includes a noise component, gradation expression is not possible in the captured image due to the signal buried in the noise, even though the signal can express gradation. In a manner similar to the first exemplary embodiment, an RMS value is introduced as a noise level, and as for visibility, a smallest signal exceeding the noise level is introduced as a code that allows visual recognition. However, various schemes are proposed for guidelines of noise and visibility, and a scheme to be employed is not limited to this example. In the present exemplary embodiment, the noise level is calculated using a table prepared beforehand based on exposure setting and image quality setting, but the method for calculating the noise level is also not limited thereto. For example, in a case of RMS value=2.8, a code value that allows visual recognition, i.e., the smallest code value exceeding 2.8, is 3, and an object luminance corresponding to the code value 3 is calculated as 1.28 cd/m². This indicates that, despite the minimum luminance 1.0 cd/m² being input by the user, gradation expression is possible only in 1.28 cd/m² or more. Therefore, to express 1.0 cd/m² expected by the user, the setting is changed to suppress the RMS value to be 2.0 or less, by increasing the noise reduction setting or decreasing the noise addition control. As a result, the smallest code value exceeding the noise level is 2, and a luminance that allows visual recognition apart from a noise component is 0.855 cd/m². The gradation expression for 1.0 cd/m² expected by the user is therefore possible.

According to the processing described above, the exposure and the image quality of the camera are controlled according to the maximum luminance value and the minimum luminance value input by the user operation. Therefore, the user can intuitively operate the camera, in connection with the luminance range of the object that allows gradation expression by the captured image.

Although a gradation conversion characteristic is not considered in this example, in reality, there may be a case where a code value cannot express gradation due to gradation conversion. For example, assume that there is an input signal of a part, in which the slope of a conversion characteristic is less than 1 in a gradation conversion characteristic for converting an image signal of 14 bits into 10 bits. In this case, although the input signal can express gradation expression, distinguishing of gradation may not be possible in the code value after gradation conversion. In such a case, the exposure and the image quality is controlled in such a manner that, as the code value after conversion, an input luminance of a code value in which gradation can be distinguished becomes a minimum luminance value or a maximum luminance value expected by the user.

### Other Exemplary Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above-described exemplary embodiments, it is possible to operate an imaging apparatus, while intuitively understanding a luminance range that allows gradation expression in a captured image, and setting of the imaging apparatus.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-213541, filed Oct. 31, 2016, which is hereby incorporated by reference herein in its entirety.

What is claimed is:

1. An imaging apparatus comprising:
an acquisition unit configured to acquire a luminance range that allows gradation expression in an image to be captured, based on setting information when an image is generated; and
a presentation unit configured to present the luminance range.

2. The imaging apparatus according to claim 1, further comprising:
a setting unit configured to set the luminance range; and
a control unit configured to change setting information of the imaging apparatus, based on the set luminance range.

3. The imaging apparatus according to claim 2, wherein the setting information is information about at least one of exposure and image quality of the imaging apparatus.

4. The imaging apparatus according to claim 2, further comprising an image processing unit configured to generate display data for displaying the luminance range,
wherein the presentation unit displays the display data superimposed on an image.

5. The imaging apparatus according to claim 4,
wherein the acquisition unit calculates a maximum luminance value and a minimum luminance value that allow gradation expression in an image to be captured, based on the setting information, and
wherein the image processing unit generates display data for displaying the calculated maximum luminance value and minimum luminance value and displays the display data superimposed on an image.

6. The imaging apparatus according to claim 5, wherein the minimum luminance value is calculated based on a smallest code value exceeding a noise level.

7. The imaging apparatus according to claim 6, wherein the noise level is changeable according to at least one of exposure setting, noise reduction setting, gradation conversion characteristic, and noise addition setting for adding noise to an image signal, of the imaging apparatus.

8. The imaging apparatus according to claim 5, wherein the setting unit accepts either one of operation for selecting a maximum luminance and a minimum luminance, and operation for selecting a preset combination of a minimum luminance and a maximum luminance.

9. The imaging apparatus according to claim 5, wherein the control unit changes exposure setting according to a maximum luminance set by the setting unit, and controls a noise level according to a minimum luminance set by the setting unit.

10. A method for an imaging apparatus, the method comprising:
acquiring a luminance range that allows gradation expression in an image to be captured, based on setting information when an image is generated; and
presenting the luminance range.

11. The method according to claim 10, further comprising:
setting the luminance range; and
changing setting information of the imaging apparatus, based on the set luminance range.

12. The method according to claim 11, wherein the setting information is information about at least one of exposure and image quality of the imaging apparatus.

13. The method according to claim 11, further comprising:
generating display data for displaying the luminance range; and
displaying the display data superimposed on an image.

14. The method according to claim 13, further comprising:
calculating a maximum luminance value and a minimum luminance value that allow gradation expression in an image to be captured, based on the setting information; and
generating display data for displaying the calculated maximum luminance value and minimum luminance value and displaying the display data superimposed on an image.

15. The method according to claim 14, wherein the minimum luminance value is calculated based on a smallest code value exceeding a noise level.

16. A computer-readable storage medium storing a program of instructions for causing a computer to perform a method comprising:
acquiring a luminance range that allows gradation expression in an image to be captured, based on setting information when an image is generated; and
presenting the luminance range.

17. The computer-readable storage medium according to claim 16, further comprising:
setting the luminance range; and
changing setting information of the imaging apparatus, based on the set luminance range.

18. The computer-readable storage medium according to claim 17, wherein the setting information is information about at least one of exposure and image quality of the imaging apparatus.

19. The computer-readable storage medium according to claim 17, further comprising:
generating display data for displaying the luminance range; and
displaying the display data superimposed on an image.

20. The computer-readable storage medium according to claim 19, further comprising:
calculating a maximum luminance value and a minimum luminance value that allow gradation expression in an image to be captured, based on the setting information; and
generating display data for displaying the calculated maximum luminance value and minimum luminance value and displaying the display data superimposed on an image.
